(19) United States
(12) Patent Application Publication
(10) Pub. No.: US 2026/0163371 A1
(43) Pub. Date: Jun. 11, 2026

(54) DECOUPLING EVALUATION METHOD FOR WIND POWER PREDICTION ERROR BASED ON K-NEAREST NEIGHBOR SEARCH

(71) Applicant: HUNAN UNIVERSITY, Changsha (CN)

(72) Inventors: Lipeng ZHU, Changsha (CN); Yuchen HUANG, Changsha (CN); Limengqian ZHENG, Changsha (CN); Anyan LIU, Changsha (CN); Jiayong LI, Changsha (CN); Cong ZHANG, Changsha (CN)

(73) Assignee: HUNAN UNIVERSITY, Changsha (CN)

(21) Appl. No.: 19/409,844

(22) Filed: Dec. 5, 2025

(30) Foreign Application Priority Data
Dec. 6, 2024 (CN) 202411792085.1

(51) Int. Cl. H02J 3/00; G06Q 50/06

(52) U.S. Cl. CPC H02J 3/003; G06Q 50/06

(57) ABSTRACT

A decoupling evaluation method for a wind power prediction error based on k-nearest neighbor search first calculates a prediction error caused by a power correction stage based on information of planned and actual available capacities, finds real meteorological data closest to numerical weather prediction (NWP) data from historical operation data based on a k^{th}-order nearest neighbor principle, estimates, through average approximation of a k^{th}-order nearest neighbor, a prediction error caused by a modeling stage, and finally calculates a prediction error caused by an NWP stage based on a total prediction error. The method does not need to directly obtain a predicted wind power conversion model of a wind farm, but performs highly-reliable quantitative evaluation on errors of different stages in a wind power prediction process to further obtain an error contribution rate of each stage, thereby accurately locating a weak stage of a wind power prediction algorithm.

### CROSS REFERENCE TO THE RELATED APPLICATIONS

This application is based upon and claims priority to Chinese Patent Application No. 202411792085.1, filed on Dec. 6, 2024, the entire contents of which are incorporated herein by reference.

### TECHNICAL FIELD

The present disclosure relates to the technical field of wind power control, and in particular, to a decoupling evaluation method for a wind power prediction error based on k-nearest neighbor search.

### BACKGROUND

In recent years, with the large-scale grid connection of wind power, the intermittency and volatility of wind power output have made randomness and uncertainty in the daily operation of power systems particularly prominent, posing a significant challenge to the safe and economic operation of power systems. To effectively address the adverse impacts of large-scale wind power integration, it is necessary to accurately and reliably predict the wind power.

Currently, data-driven methods have become the mainstream approach for power output prediction. However, because data-driven wind power prediction methods directly mine and learn the mapping relationship between observed data and predicted wind power values through machine learning algorithms such as long short-term memory (LSTM), random forest (RF), and support vector machine (SVM), they fail to fully reflect the complex coupling relationships among various stages of the wind power prediction process. To improve prediction accuracy, existing studies primarily focus on evaluating the final power prediction error, with little emphasis on conducting full-process temporal evaluations of power prediction. In fact, the wind power prediction process can be, based on the business process, divided into three stages: the numerical weather prediction (NWP) stage, the meteorology-to-power conversion (modeling) stage, and the power correction stage. If a key stage causing prediction error in the wind power prediction process can be effectively identified, the accuracy of wind power prediction can be improved more efficiently. Thus, on the basis of comprehensively analyzing statistical characteristics of wind power errors, conducting efficient and reliable decoupling analysis of the error generated at each stage of the wind power prediction process can provide key technical support for performance evaluation, improvement, and optimization of power prediction algorithms.

### SUMMARY

To effectively identify a key stage causing prediction errors in wind power prediction, the present disclosure provides a decoupling evaluation method for wind power prediction errors based on k-nearest neighbor search.

In order to solve the above technical problem, the present disclosure adopts the following technical method: A decoupling evaluation method for wind power prediction errors based on k-nearest neighbor search includes:
step S1, acquiring meteorological, capacity, and power data of a wind farm;
step S2, calculating a total prediction error E of the wind farm and quantitatively evaluating a prediction error caused by each stage of a wind power prediction process, where the wind power prediction process includes three stages: the numerical weather prediction (NWP) stage, the modeling stage, and the power correction stage, and the step S2 includes the following substeps:
S201, calculating the difference between a predicted power P₁ and a corresponding actual power P₀ of the wind farm to obtain the total prediction error E;
S202, first calculating an equivalent power prediction value P_{cap} under the condition of accurate available capacity, and then computing the difference between the predicted power P₁ of the wind farm and the equivalent power prediction value P_{cap} to obtain the prediction error Eᵣ caused by the power correction stage;
S203, constructing a k-nearest neighbor model for fast nearest neighbor search, fitting the model using historical meteorological data Uₛ to form an index relationship between the historical meteorological data Uₛ and historical power data Pₛ, performing nearest neighbor search for each sample in an NWP dataset U₀ by using a fitted k-nearest neighbor model to find an average actual power

$${P}_{i}^{k}$$

corresponding to each sample under a k^{th}-order nearest neighbor, obtaining an average actual power dataset P₂ of all samples, and taking the difference between the equivalent power prediction value P_{cap} and the average actual power dataset P₂ as a prediction error Eₘ caused by the modeling stage; and
S204, subtracting the prediction error Eᵣ caused by the power correction stage and the prediction error Eₘ caused by the modeling stage from the obtained total prediction error E of the wind farm to obtain a prediction error Eₙ caused by the NWP stage; and

step S3, separately normalizing the prediction error caused by the NWP stage, the prediction error caused by the modeling stage, and the prediction error caused by the power correction stage to obtain error contribution rates of the three stages, and comparing values of the error contribution rates of the three stages to determine a key stage causing prediction errors in the wind power prediction process.

Further, the step S203 includes:
1) obtaining the NWP dataset U₀ at the same time point as the actual power P₀ of the wind farm, as well as the historical meteorological data Uₛ and the historical power data Pₛ that are acquired by a supervisory control and data acquisition (SCADA) system;
2) initializing the k-nearest neighbor model for fast nearest neighbor search, using a k-dimensional tree (KD tree) as a feature space partitioning algorithm, calculating an inter-sample distance based on a Euclidean distance, fitting the k-nearest neighbor model by using the Uₛ, and constructing a spatial index for subsequent nearest neighbor search on the Uₛ;
3) denoting a sample at an p^{th} time point in the U₀ as Xᵢ, performing the nearest neighbor search on the Xᵢ by using the fitted k-nearest neighbor model, finding k pieces of historical meteorological data closest to the Xᵢ from the Uₛ, recording historical meteorological data indexes, obtaining a corresponding actual power dataset Pₖ from the Pₛ based on the indexes, calculating an average value of k pieces of actual power data in the Pₖ, and obtaining the average actual power

$${P}_{i}^{k}$$

under the k^{th}-order nearest neighbor; and
4) repeating step 3) until all t samples in the U₀ are traversed, denoting an average actual power dataset of all the samples as the P₂, and taking the difference between the P_{cap} and the P₂ as the prediction error Eₘ caused by the modeling stage.

Further, in the step S202, a planned available capacity and an actual available capacity of the wind farm are respectively denoted as C′=[C′₁, . . . C′ᵢ . . . , C′ₜ] and C=[C₁, . . . Cᵢ . . . , Cₜ], where i represents the i^{th} time point and t represents a total quantity of samples, the equivalent power prediction value P_{cap} under the accurate available capacity is first calculated, and then the prediction error Eᵣ caused by the power correction stage is calculated, as shown in following formulas:

$${P}_{c a p} = \frac{C}{{C}^{′}} {P}_{1} , and \qquad ( 1 )$$

$${E}_{r} = {P}_{1} - {P}_{c a p} = ( 1 - \frac{C}{{C}^{′}} ) {P}_{1} . \qquad ( 2 )$$

Further, the step S3 includes:
1) calculating a sum Sᵣ of absolute values of all the samples in the Eᵣ, a sum Sₘ of absolute values of all the samples in the Eₘ, and a sum Sₙ of absolute values of all the samples in the Eₙ, as shown in following formulas:

$${S}_{r} = {\sum }_{i = 1}^{t} \vert {E}_{r , i} \vert , \qquad ( 3 )$$

$${S}_{m} = {\sum }_{i = 1}^{t} \vert {E}_{m , i} \vert , \qquad ( 4 )$$

$${S}_{n} = {\sum }_{i = 1}^{t} \vert {E}_{n , i} \vert , \qquad ( 5 )$$

where E_{r,i}, E_{m,i}, and E_{n,i} respectively represent quantities of samples at the i^{th} time point in the Eᵣ, the Eₘ, and the Eₙ, and the total quantity of samples is denoted as t;
2) normalizing the Eᵣ, the Eₘ, and the Eₙ separately, and obtaining the error contribution rate Rᵣ of the NWP stage, the error contribution rate μm of the modeling stage, and the error contribution rate Rₙ of the power correction stage, as shown in following formulas:

$${R}_{r} = \frac{{S}_{r}}{{S}_{r} + {S}_{m} + {S}_{n}} , \qquad ( 6 )$$

$${R}_{m} = \frac{{S}_{m}}{{S}_{r} + {S}_{m} + {S}_{n}} , and \qquad ( 7 )$$

$${R}_{n} = \frac{{S}_{n}}{{S}_{r} + {S}_{m} + {S}_{n}} ; \qquad ( 8 )$$

3) comparing the values of the error contribution rate Rᵣ of the NWP stage, the error contribution rate Rₘ of the modeling stage, and the error contribution rate Rₙ of the power correction stage, where a larger value indicates a greater impact of a prediction error caused by a corresponding stage in the wind power prediction process.

Preferably, both the NWP dataset U₀ and the historical meteorological data Uₛ are meteorological data of the wind farm, which includes wind speeds, wind directions, temperatures, humidity, and air pressures at different heights.

A decoupling evaluation method for a wind power prediction error based on k-nearest neighbor search provided in the present disclosure can achieve decoupling evaluation for an error in each stage in a wind power prediction process. Further, the present disclosure first calculates a prediction error caused by a power correction stage based on information of planned and actual available capacities, finds real meteorological data closest to NWP data from historical operation data based on a k^{th}-order nearest neighbor principle, estimates, through average approximation of a k^{th}-order nearest neighbor, a prediction error caused by a modeling stage, and finally calculates a prediction error caused by an NWP stage based on a total prediction error. The present disclosure does not need to directly obtain a predicted wind power conversion model of a wind farm, but performs highly-reliable quantitative evaluation on errors of different stages in the wind power prediction process to further obtain an error contribution rate of each stage, thereby accurately locating a weak stage of a wind power prediction algorithm and providing more comprehensive prediction error analysis from a perspective of a power prediction business process. The present disclosure can guide existing prediction algorithms to improve and optimize a weak prediction stage, thereby further enhancing the precision of wind power prediction, and also helps to improve real-time, comprehensive, and reliable full-process perception of a power prediction level by a wind power generation dispatching platform for each wind farm station in each region.

### BRIEF DESCRIPTION OF THE DRAWINGS

FIG. 1 is a flowchart of a decoupling evaluation method for a wind power prediction error based on k-nearest neighbor search according to the present disclosure;

FIG. 2 is a schematic view of an overall structure of a wind farm simulation model according to an implementation of the present disclosure; and

FIGS. 3A and 3B schematically show error decoupling evaluation results of a wind farm in different months under different values of k according to an implementation of the present disclosure (where FIG. 3A schematically shows changes in error contribution rates of an NWP stage and a modeling stage in the wind farm in September under the different values of the k; and FIG. 3B schematically shows changes in error contribution rates of the NWP stage and the modeling stage in the wind farm in October under the different values of the k).

### DETAILED DESCRIPTION OF THE EMBODIMENTS

For the convenience of understanding by those skilled in the art, the present disclosure will be further described with reference to the embodiments and accompanying drawings. The content mentioned in the implementations is not intended to limit the present disclosure.

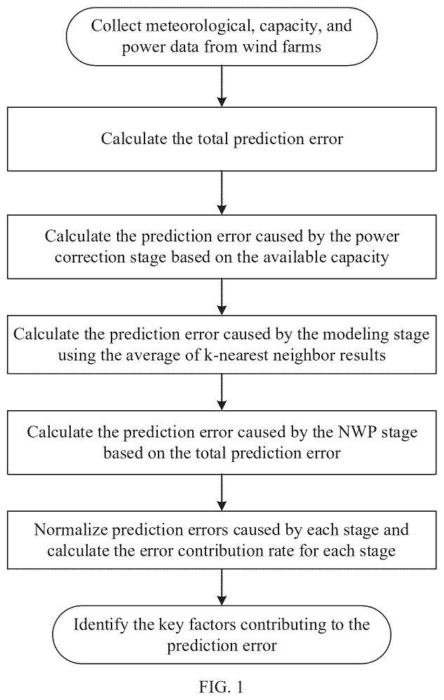

As shown in FIG. 1, a decoupling evaluation method for a wind power prediction error based on k-nearest neighbor includes the following steps:

Step S1: Meteorological data, capacity data, and power data of a wind farm in central China at a plurality of different time points are acquired.

The meteorological data of the wind farm includes NWP dataset U₀ and historical meteorological data Uₛ. These datasets contain wind speeds, wind directions, temperatures, humidity, and air pressures at different heights. Meteorological data in the NWP dataset U₀ is NWP data, where U₀=[U₀₁, . . . U₀, . . . , U₀ₜ], i represents an i^{th} time point, and t represents the total number of samples. The U₀ is provided by a power prediction vendor. Specifically, a global meteorological prediction field is first downloaded from an authoritative meteorological institution. Then, the global atmospheric prediction field data is standardized in format so that it becomes suitable for driving the mesoscale NWP model software and for completing all preparations required before running the model. Finally, based on the prediction need of detailed geographical coordinates, the power prediction vendor runs the mesoscale NWP model software to complete downscaling calculation of a local target region, thereby obtaining the atmospheric conditions of the wind-farm region at various future time points. The historical meteorological data Uₛ is real meteorological data acquired by a SCADA system.

The capacity data of the wind farm includes planned available capacity C′=[C′₁, . . . C′ᵢ . . . , C′ₜ] and actual available capacity C=[C₁, . . . Cᵢ . . . , Cₜ], where i represents the i^{th} time point, and t represents the total quantity of samples.

The power data of the wind farm includes actual power P₀=[P₀₁, . . . P₀ᵢ . . . , P₀ₜ] and predicted power P₁=[P₁₁, . . . P₁ᵢ . . . , P₁ₜ] over the same time period, as well as historical power data Pₛ corresponding to the historical meteorological data Uₛ. Both the P₀ and Pₛ are actual power generation outputs from the wind farm and are acquired by the SCADA system. The P₁ is the power obtained by performing wind power conversion on the NWP dataset U₀ during the modeling stage (It is worth noting herein that a predicted wind power conversion model provided by the power prediction vendor is adopted for data processing in the modeling stage. The predicted wind power conversion model is a mathematical expression used to describe a relationship between meteorological data and wind power output data. A mapping between a meteorological factor and a wind power is usually constructed based on a data-driven method, thereby completing the prediction and estimation of the wind power). In addition, i represents the i^{th} time point, and t represents the total quantity of samples.

Step S2: Total prediction error E of the wind farm is calculated, and a prediction error caused by each stage of a wind power prediction process is quantitatively evaluated, where the wind power prediction process includes an NWP stage, the modeling stage, and a power correction stage.

S201: A difference between the predicted power P₁ and the corresponding actual power P₀ of the wind farm is calculated to obtain the total prediction error E of the wind farm, as shown in the following formula:

$$E = {P}_{1} - {P}_{0} = {E}_{n} + {E}_{m} + {E}_{r} \qquad ( 9 )$$

S202: Equivalent power prediction value P_{cap} under an accurate available capacity is first calculated, and then prediction error Eᵣ caused by the power correction stage is calculated, as shown in the following formulas:

$${P}_{c a p} = \frac{C}{{C}^{′}} {P}_{1} \qquad ( 1 )$$

$${E}_{r} = {P}_{1} - {P}_{c a p} = ( 1 - \frac{C}{{C}^{′}} ) {P}_{1} \qquad ( 2 )$$

S203: A prediction error caused by the modeling stage is calculated through k-nearest neighbor averaging. Specifically:
1) The NWP dataset U₀ at the same time point as the actual power P₀ of the wind farm, and the historical meteorological data Uₛ and the historical power data Pₛ that are acquired by the SCADA system are obtained.
2) A k-nearest neighbor model for fast nearest neighbor search is initialized (this model is different from a traditional classification or regression model, and is a nearest neighbor search model specifically designed to find k nearest neighbors of a sample, where k is denoted as a quantity of neighbors). A KD tree is used as a feature space partitioning algorithm (the KD tree is of a binary tree structure that can directly exclude a region far from a query point, thus quickly searching for a nearest neighbor). An inter-sample distance is calculated based on a Euclidean distance (a Euclidean distance between samples x and y is calculated as

$$d ( x , y ) = \sqrt{{\sum }_{i = 1}^{n} {( {x}_{i} - {y}_{i} )}^{2}} ,$$

where n denotes the number of features). The k-nearest neighbor model is fitted by using the Uₛ. In this process, a spatial index is constructed on the Uₛ to facilitate fast nearest neighbor search in the future. After the fitting, a nearest neighbor of any given sample in the Uₛ can be directly queried. In this embodiment, a k-nearest neighbor algorithm is implemented using a Sklearn toolbox in a Python environment.

3) A sample at the i^{th} time point in the U₀ is denoted as Xᵢ, nearest neighbor search is performed on the Xᵢ by using a fitted k-nearest neighbor model, k pieces of historical meteorological data closest to the Xᵢ are found from the Uₛ, historical meteorological data indexes are recorded, corresponding actual power dataset Pₖ is obtained from the Pₛ based on the indexes, an average value of k pieces of actual power data in the Pₖ is calculated, and average actual power

$${P}_{i}^{k}$$

under a k^{th}-order nearest neighbor is obtained.

4) The step 3) is repeated until all t samples in the U₀ are traversed, an average actual power dataset of all the samples is denoted as the P₂, and a difference between the P_{cap} and the P₂ is taken as the prediction error Eₘ caused by the modeling stage, as shown in the following formula:

$${E}_{m} = {P}_{c a p} - {P}_{2} \qquad ( 10 )$$

S204: The prediction error Eᵣ caused by the power correction stage and the prediction error Eₘ caused by the modeling stage are subtracted from the obtained total prediction error E of the wind farm to obtain prediction error Eₙ caused by the NWP stage, as shown in the following formula:

$${E}_{n} = E - {E}_{r} - {E}_{m} = {P}_{2} - {P}_{0} \qquad ( 11 )$$

Step S3: The prediction error caused by the NWP stage, the prediction error caused by the modeling stage, and the prediction error caused by the power correction stage are separately normalized to obtain error contribution rates of the three stages, and values of the error contribution rates of the three stages are compared to determine a key stage causing a prediction error in the wind power prediction process. Specifically:
1) Sum Sᵣ of absolute values of the t samples in the Eᵣ, sum Sₘ of the absolute values of the t samples in the Eₘ, and sum Sₙ of the absolute values of the t samples in the Eₙ are calculated, as shown in the following formulas:

$${S}_{r} = {\sum }_{i = 1}^{t} \vert {E}_{r , i} \vert \qquad ( 3 )$$

$${S}_{m} = {\sum }_{i = 1}^{t} \vert {E}_{m , i} \vert \qquad ( 4 )$$

$${S}_{n} = {\sum }_{i = 1}^{t} \vert {E}_{n , i} \vert \qquad ( 5 )$$

where E_{r,i}, E_{m,i}, and E_{n,i} respectively represent quantities of samples at the i^{th} time point in the Eᵣ, the Eₘ, and the Eₙ, and the total quantity of samples is denoted as t.
2) The Eᵣ, the Eₘ, and the Eₙ are normalized separately, and the error contribution rate Rᵣ of the NWP stage, the error contribution rate Rₘ of the modeling stage, and the error contribution rate Rₙ of the power correction stage are obtained, as shown in the following formulas:

$${R}_{r} = \frac{{S}_{r}}{{S}_{r} + {S}_{m} + {S}_{n}} \qquad ( 6 )$$

$${R}_{m} = \frac{{S}_{m}}{{S}_{r} + {S}_{m} + {S}_{n}} \qquad ( 7 )$$

$${R}_{n} = \frac{{S}_{n}}{{S}_{r} + {S}_{m} + {S}_{n}} \qquad ( 8 )$$

3) The values of the error contribution rate Rᵣ of the NWP stage, the error contribution rate Rₘ of the modeling stage, and the error contribution rate Rₙ of the power correction stage are compared, and a cause of an overall wind power prediction error can be further analyzed based on the values of the error contribution rates, in order to locate a weak stage in the wind power prediction process and guide the improvement in the precision of subsequent wind power prediction.

To verify the reliability of the method proposed in the present disclosure, a verification scenario for error decoupling evaluation is constructed using Simulink. Considering that a prediction error of a correction stage in a power prediction process of a wind farm is usually very small, this verification scenario does not take into account the impact of the error of the correction stage. It is defaulted that the available capacity of the wind farm has no deviation.

I. Decoupling evaluation is performed on a wind power prediction error through Simulink simulation.

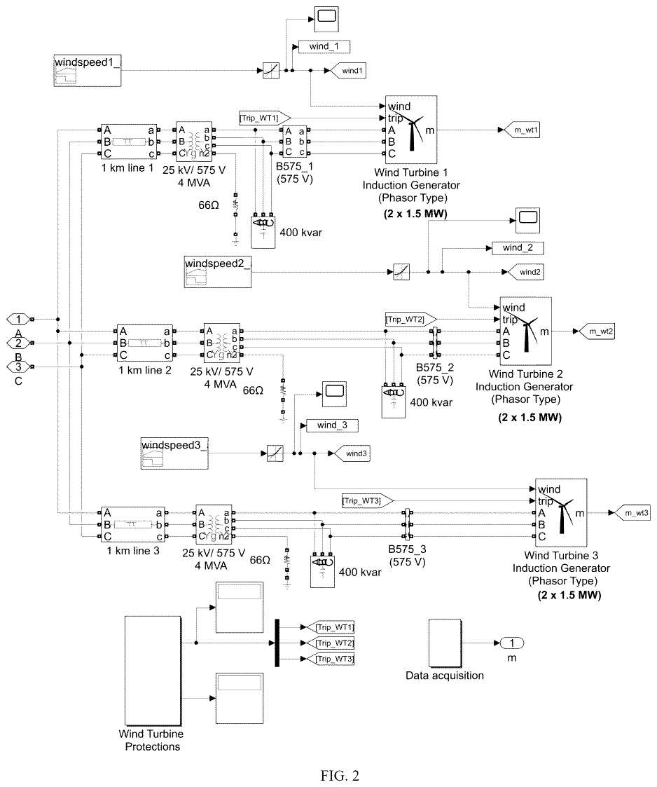

Firstly, a wind farm simulation model is constructed using Simulink. The wind farm simulation model provided in an official documentation of a Matrix Laboratory (MATLAB) is taken as a simulation case, and its overall structure is shown in FIG. 2. The wind farm consists of three wind turbines with a rated power of 3 MW, is connected to a 25 kV distribution system, and transmits power to a 120 kV power grid through a 25 km-long 25 kV feeder. Next, eight different meteorological datasets are specified based on a historical real scenario of the wind farm, and these eight meteorological datasets are divided into four actual meteorological datasets U₀* and four NWP datasets U₀. The above data is then input into a Simulink simulation model separately, to obtain actual power P₀ of the wind farm when the actual meteorological datasets U₀* are used as an input, and actual power P₀* of the wind farm when the NWP datasets U₀ are used as an input. In the above Simulink simulation, a difference between the output P₀* and the output P₀ lies only in the input data, that is, the NWP datasets U₀ are different from the actual meteorological datasets U₀*. Therefore, a prediction error caused by an NWP stage in the Simulink simulation can be calculated as follows: Eₙ=P₀*−P₀. After that, a convolutional neural network (CNN)-based wind power prediction model is trained (another prediction algorithm can also be selected herein, and selection of a prediction algorithm does not affect verification of the effectiveness of the error decoupling evaluation method). The NWP datasets U₀ are input into a trained wind power prediction model to obtain predicted power P₂*. At this time, a total prediction error of the wind farm is E=P₂*−P₀. Since the total prediction error is a sum of a prediction error of each stage, a prediction error caused by a modeling stage can be expressed as Eₘ=E−Eₙ. Finally, the prediction error caused by the NWP stage and the prediction error caused by the modeling stage are separately normalized, and error contribution rates of the corresponding stages are obtained, as shown in Table 1 below.

II. The decoupling evaluation is performed on the wind power prediction error in the Simulink simulation scenario by using the method proposed in the present disclosure.

Parameter t and parameter k in the method proposed in the present disclosure are respectively set to 8408 and 20. The NWP dataset U₀, the actual power P₀ of the wind farm, and the predicted power P₂* of the wind farm in the Simulink simulation scenario are respectively taken as NWP dataset U₀, actual power P₀ of the wind farm, and predicted power Pᵢ of the wind farm in the method proposed in the present disclosure. The method proposed in the present disclosure is used to perform the decoupling evaluation on the prediction errors of the NWP stage and the modeling stage, and normalize the prediction errors to obtain the error contribution rates of the corresponding stages, as shown in Table 1 below.

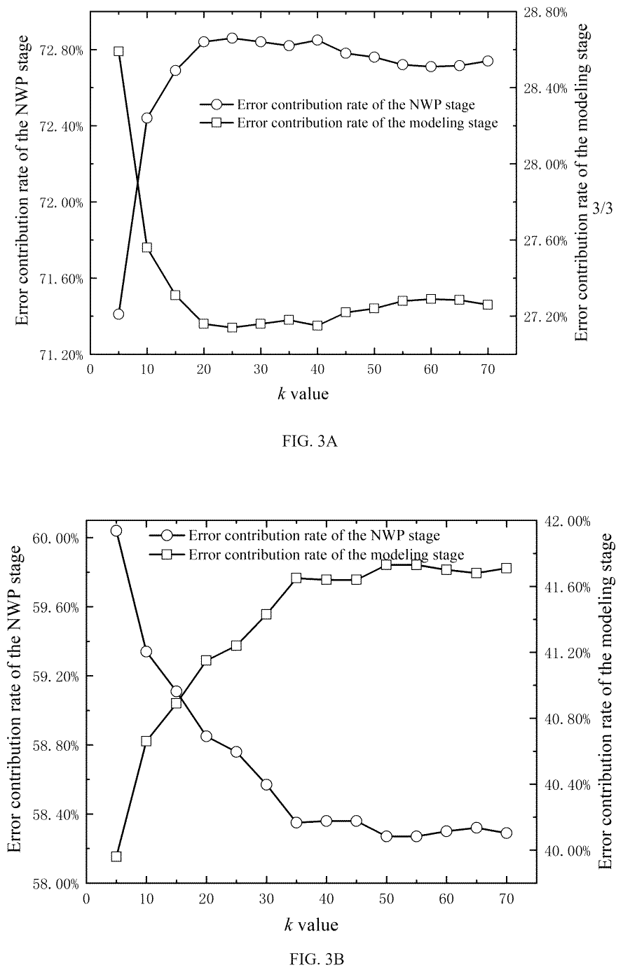

It is worth noting that the k is the most important parameter in the method proposed in the present disclosure. Before the verification experiment is conducted, it is advisable to acquire historical operation data of the wind farm to perform sensitivity analysis on the k, so as to summarize error contribution rates of different stages under different values of the k. As shown in FIGS. 3A and 3B, under different values of the k, an error contribution rate of the NWP stage in September increases slightly with an increase in a value of the k, from 71.40% to approximately 72.86%, while the error contribution rate of the NWP stage in October decreases with the increase in the value of the k, mainly varying within a range of 60.00% to 58.20%. Overall, with a change in the value of the k, an error contribution rate that is of each stage and calculated by using the method proposed in the present disclosure changes slightly, but the fluctuation range is very small. Maximum error fluctuations of both the NWP stage and the modeling stage do not exceed 1.80%, which fully indicates that the method proposed in the present disclosure has good robustness and adaptability under different values of the k. Moreover, it can be seen from FIG. 3A that when the value of the k exceeds 20, a fluctuation of the error contribution rate of each stage tends to be stable. A result in FIG. 3B shows that a change in the error contribution rate in October becomes more stable when the value of the k is greater than 35, but in fact, the difference between the change in the error contribution rate when the value of the k is greater than 35 and the change in the error contribution rate when k=20 does not exceed 0.4%. Therefore, in the verification scenario, the k is preferably set to 20.

III. Error contribution rate results obtained by the method proposed in the present disclosure and the Simulink simulation are observed and compared to evaluate the accuracy of the method proposed in the present disclosure. Table 1 below shows error decoupling evaluation results of the two methods when different NWP datasets are used.

TABLE 1
Comparative verification results of error decoupling evaluation

| | | Error contribution | |
|---|---|---|---|
| | | rate of the NWP | Error contribution rate |
| NWP dataset | Decoupling method | stage | of the modeling stage |
| First NWP | Simulink simulation | 58.39% | 41.61% |
| dataset | The method proposed in | 60.11% | 39.89% |
| | the present disclosure | | |
| Second NWP | Simulink simulation | 66.33% | 33.67% |
| dataset | The method proposed in | 67.49% | 32.51% |
| | the present disclosure | | |
| Third NWP | Simulink simulation | 55.12% | 44.88% |
| dataset | The method proposed in | 56.73% | 43.27% |
| | the present disclosure | | |
| Fourth NWP | Simulink simulation | 70.64% | 29.36% |
| dataset | The method proposed in | 72.06% | 27.94% |
| | the present disclosure | | |

As can be seen from Table 1, the error decoupling evaluation results obtained by both the method proposed in the present disclosure and the Simulink simulation indicate that the prediction error caused by the NWP stage is the largest, and the prediction error caused by the modeling stage is also considerable. It can thus be concluded that in the verification experiment, the precision of the NWP stage is the main cause of the prediction error, while the prediction performance of a predicted wind power conversion model adopted in the modeling stage is an important cause of the prediction error. In addition, Table 1 shows that the error contribution rate obtained by the method proposed in the present disclosure is very close to that obtained by the Simulink simulation, with a maximum error between them not exceeding 1.7500, which confirms the efficacy of the method proposed in the present disclosure. It is worth noting that in the method proposed in the present disclosure, if sufficient historical data is available to match meteorological data closest to the NWP dataset, decoupling evaluation accuracy of the method proposed in the present disclosure will be further improved.

The above embodiment is a preferred implementation of the present disclosure. In addition, the present disclosure can also be implemented in other ways, and any obvious replacement without departing from the concept of the technical solutions in the present disclosure is within the protection scope of the present disclosure.

In order to facilitate those skilled in the art to better understand improvements of the present disclosure compared to the prior art, some of the accompanying drawings and descriptions of the present disclosure have been simplified, and for the sake of clarity, some other elements have been omitted from the present application document. Those skilled in the art should be aware that these omitted elements can also constitute the content of the present disclosure.

1. A decoupling evaluation method for a wind power prediction error based on a k-nearest neighbor search, comprising:
step S1, acquiring meteorological, capacity, and power data of a wind farm;
step S2, calculating a total prediction error E of the wind farm, and quantitatively evaluating a prediction error caused by each stage of a wind power prediction process, wherein the wind power prediction process comprises three stages: a numerical weather prediction (NWP) stage, a modeling stage, and a power correction stage, and the step S2 comprises the following substeps:
S201, calculating the difference between a predicted power P₁ and a corresponding actual power P₀ of the wind farm to obtain the total prediction error E of the wind farm;
S202, first calculating an equivalent power prediction value P_{cap} under an accurate available capacity, and then taking the difference between the predicted power Pᵢ of the wind farm and the equivalent power prediction value P_{cap} as a prediction error Eᵣ caused by the power correction stage;
S203, constructing a k-nearest neighbor model for fast nearest neighbor search, fitting the k-nearest neighbor model using historical meteorological data Uₛ to form an index relationship between the historical meteorological data Uₛ and historical power data Pₛ, performing nearest neighbor search for each sample in an NWP dataset U₀ by using a fitted k-nearest neighbor model to find an average actual power
$${P}_{i}^{k}$$
corresponding to each sample under a k^{th}-order nearest neighbor, obtaining an average actual power dataset P₂ of all the samples, and taking the difference between the equivalent power prediction value P_{cap} and the average actual power dataset P₂ as a prediction error Eₘ caused by the modeling stage; and
S204, subtracting the prediction error Eᵣ caused by the power correction stage and the prediction error Eₘ caused by the modeling stage from the total prediction error E of the wind farm to obtain a prediction error Eₙ caused by the NWP stage; and
step S3, separately normalizing the prediction error caused by the NWP stage, the prediction error caused by the modeling stage, and the prediction error caused by the power correction stage to obtain error contribution rates of the three stages, and comparing values of the error contribution rates of the three stages to determine a key stage causing a prediction error in the wind power prediction process.

2. The decoupling evaluation method for the wind power prediction error based on the k-nearest neighbor search according to claim 1, wherein the step S203 comprises:
1) obtaining the NWP dataset U₀ at the same time point as the actual power P₀ of the wind farm, and the historical meteorological data Uₛ and the historical power data Pₛ that are acquired by a supervisory control and data acquisition (SCADA) system;
2) initializing the k-nearest neighbor model for fast nearest neighbor search, using a k-dimensional tree (KD tree) as a feature space partitioning algorithm, calculating an inter-sample distance based on a Euclidean distance, fitting the k-nearest neighbor model by using the Uₛ, and constructing a spatial index for subsequent nearest neighbor search on the Uₛ;
3) denoting a sample at an i^{th} time point in the U₀ as Xᵢ, performing the nearest neighbor search on the Xᵢ by using the fitted k-nearest neighbor model, finding k pieces of historical meteorological data closest to the Xᵢ from the Uₛ, recording historical meteorological data indexes, obtaining a corresponding actual power dataset Pₖ from the Pₛ based on the indexes, calculating an average value of k pieces of actual power data in the Pₖ, and obtaining the average actual power
$${P}_{i}^{k}$$
under the k^{th}-order nearest neighbor; and
4) repeating the step 3) until all t samples in the U₀ are traversed, denoting an average actual power dataset of all the samples as the P₂, and taking a difference between the P_{cap} and the P₂ as the prediction error Eₘ caused by the modeling stage.

3. The decoupling evaluation method for the wind power prediction error based on the k-nearest neighbor search according to claim 2, wherein in the step S202, a planned available capacity and an actual available capacity of the wind farm are respectively denoted as C′=[C′₁, . . . C′ᵢ . . . , C′ₜ] and C=[C₁, . . . Cᵢ . . . , Cₜ], wherein i represents the i^{h} time point and t represents a total quantity of samples, the equivalent power prediction value P_{cap} under the accurate available capacity is first calculated, and then the prediction error Eᵣ caused by the power correction stage is calculated, as shown in the following formulas:
$${P}_{c a p} = \frac{C}{{C}^{′}} {P}_{1} , and \qquad ( 1 )$$
$${E}_{r} = {P}_{1} - {P}_{c a p} = ( 1 - \frac{C}{{C}^{′}} ) {P}_{1} . \qquad ( 2 )$$

4. The decoupling evaluation method for the wind power prediction error based on the k-nearest neighbor search according to claim 3, wherein the step S3 comprises:
1) calculating a sum Sᵣ of absolute values of all the samples in the Eᵣ, a sum Sₘ of absolute values of all the samples in the Eₘ, and a sum Sₙ of absolute values of all the samples in the Eₙ, as shown in the following formulas:
$${S}_{r} = {\sum }_{i = 1}^{t} \vert {E}_{r , i} \vert , \qquad ( 3 )$$
$${S}_{m} = {\sum }_{i = 1}^{t} \vert {E}_{m , i} \vert , \qquad ( 4 )$$
$${S}_{n} = {\sum }_{i = 1}^{t} \vert {E}_{n , i} \vert , \qquad ( 5 )$$
wherein E_{r,i}, E_{m,i}, and E_{n,i} respectively represent quantities of samples at the i^{th} time point in the Eᵣ, the Eₘ, and the Eₙ, and the total quantity of samples is denoted as t;
2) normalizing the Eᵣ, the Eₘ, and the Eₙ separately, and obtaining an error contribution rate Rᵣ of the NWP stage, an error contribution rate Rₘ of the modeling stage, and an error contribution rate Rₙ of the power correction stage, as shown in the following formulas:
$${R}_{r} = \frac{{S}_{r}}{{S}_{r} + {S}_{m} + {S}_{n}} , \qquad ( 6 )$$
$${R}_{m} = \frac{{S}_{m}}{{S}_{r} + {S}_{m} + {S}_{n}} , and \qquad ( 7 )$$
$${R}_{n} = \frac{{S}_{n}}{{S}_{r} + {S}_{m} + {S}_{n}} ; \qquad ( 8 )$$
3) comparing the values of the error contribution rate Rᵣ of the NWP stage, the error contribution rate Rₘ of the modeling stage, and the error contribution rate Rₙ of the power correction stage, wherein a larger value indicates a greater impact of a prediction error caused by a corresponding stage in the wind power prediction process.

5. The decoupling evaluation method for the wind power prediction error based on the k-nearest neighbor search according to claim 1, wherein both the NWP dataset U₀ and the historical meteorological data Uₛ are meteorological data of the wind farm, wherein the meteorological data of the wind farm is wind speeds, wind directions, temperatures, humidity, and air pressures at different heights.

6. The decoupling evaluation method for the wind power prediction error based on the k-nearest neighbor search according to claim 4, wherein both the NWP dataset U₀ and the historical meteorological data Uₛ are meteorological data of the wind farm, wherein the meteorological data of the wind farm is wind speeds, wind directions, temperatures, humidity, and air pressures at different heights.
